(19) United States
(12) Patent Application Publication
(10) Pub. No.: US 2012/0070019 A1
(43) Pub. Date: Mar. 22, 2012

(54) METHODS FOR ADDRESSING EQUIPMENT IN TREE NETWORKS

(76) Inventors: Barry Corlett, Brisbane, CA (US); Wendell B. Sander, Los Gatos, CA (US)

(21) Appl. No.: 12/887,472

(22) Filed: Sep. 21, 2010

(51) Int. Cl. H04R 3/00; G06F 13/10; H04R 1/10

(52) U.S. Cl. 381/122; 381/394; 710/3

(57) ABSTRACT

Electronic equipment such as hosts, hubs, and devices may be connected to form a network. The electronic equipment may include audio connectors such as four-contact plugs and jacks. Cables may be used to interconnect the audio connectors and thereby form communications paths between pieces of equipment in the network. The equipment may include uplink and downlink data interfaces having associated uplink interface addresses and downlink interface addresses. Devices and hybrid equipment may contain endpoints that are associated with components such as speakers and microphones. Equipment may also include input-output devices such as buttons that are used in gathering user input such as button press data. When a network is formed, a host can broadcast downstream data including its downlink interface address. Downstream equipment can assign uplink interface addresses, downlink interface addresses, and endpoint addresses using received downlink interface address information.

This application claims the benefit of provisional patent application No. 61/302,505, filed Feb. 8, 2010, which is hereby incorporated by reference herein in its entirety.

### BACKGROUND

Accessories are often used with electronic equipment. For example, a computer user may listen to music with a headphone accessory. The headphone accessory may have left and right speakers and, in some configurations, noise cancellation microphones for use in implementing noise cancellation. A user of a cellular telephone may use a headset accessory that has a voice microphone and speakers. Music players are often connected to accessories such as headphones and external speakers.

In environments such as these, there is a need to convey data between accessories and associated devices. Devices such as computers, cellular telephones, and media players are therefore often provided with audio jacks. Accessories such as headsets have mating plugs. A user who desires to use a headset with an electronic device may connect the headset to the electronic device by inserting the headset plug into the mating audio jack on the electronic device.

Arrangements of this type may be suitable for low bandwidth applications such as audio playback and configurations in which there are only a limited number of audio channels involved, but are generally not suitable for more demanding applications.

It would therefore be desirable to be able to provide improved techniques for handling communications between pieces of electronic equipment such as arrangements for conveying audio signals and other data between electronic devices and accessories.

### SUMMARY

Electronic equipment such as hosts, hubs, and devices may be connected to form a network. Hosts may include devices such as computers, cellular telephones, and media players. Device may include accessories such as headsets, headphones, and amplified speakers. Hubs may be coupled to a host to provide additional downstream data ports.

Hosts may transmit downstream data to hubs and devices. Hubs may receive transmitted data from the host and may convey (e.g., retransmit) the data to equipment that is further downstream. For example, audio data such as music data may be transmitted from the host to one or more devices that are connected to the host through one or more layers of hubs.

The electronic equipment may include audio connectors such as four-contact plugs and jacks. Cables may be used to interconnect the audio connectors and thereby form communications paths between pieces of equipment in the network. The equipment may include uplink and downlink data interfaces having associated uplink interface addresses and downlink interface addresses. Devices and hybrid equipment may contain endpoints that are associated with components such as speakers and microphones. Equipment may also include input-output devices such as buttons that are used in gathering user input such as button press data. When a network is formed, a host can broadcast downstream data including its downlink interface address. Downstream equipment can assign uplink interface addresses, downlink interface addresses, and endpoint addresses using received downlink interface address information.

Data may be conveyed in superframes. Each superframe may contain frames. Each frame may include a slots of data such as 8B/10B encoded data bytes. A broadcast slot may be included in each frame to form a broadcast channel. Bulk slots may be included to form a bulk channel. The broadcast channel may be used to support the broadcasting of downstream data from the host to downstream equipment. The bulk channel may be used to convey upstream and downstream data such as button press data. Traffic slots may be used to carry audio data such as audio data to be played back through the speakers in a device or audio data that has been gathered from a microphone in a device.

Further features of the invention, its nature and various advantages will be more apparent from the accompanying drawings and the following detailed description of the preferred embodiments.

### BRIEF DESCRIPTION OF THE DRAWINGS

FIG. 1 is a schematic diagram of illustrative electronic equipment of the type that may be used in a system supporting communications in accordance with an embodiment of the present invention.

FIG. 2 is a diagram showing how equipment of the type shown in FIG. 1 may be provided with connectors such as four-contact audio connectors in accordance with an embodiment of the present invention.

FIG. 3 is a diagram showing how a host and device may communicate using downlink and uplink interfaces in accordance with an embodiment of the present invention.

FIG. 4 is a diagram of a system in which multiple pieces of equipment have been connected in a tree network in accordance with an embodiment of the present invention.

FIG. 5 is a circuit diagram of illustrative hybrid equipment that includes both hub and device endpoint components in accordance with an embodiment of the present invention.

FIG. 6 is a diagram of an illustrative frame structure that may be used in communicating between equipment in a network in accordance with an embodiment of the present invention.

FIG. 7 is a diagram showing how a frame of data may include data slots associated with a downlink phase and data slots associated with an uplink phase in accordance with an embodiment of the present invention.

FIG. 8A is a diagram of a system in which pieces of equipment have not yet been coupled together in accordance with an embodiment of the present invention.

FIG. 8B is a diagram of a system in which pieces of equipment have been coupled together using a cable so that addresses may be assigned in accordance with an embodiment of the present invention.

FIG. 9 is a diagram showing how multiple levels of equipment may be interconnected in a network and showing how addresses may be assigned within the equipment in accordance with an embodiment of the present invention.

FIG. 10 is a diagram of an illustrative message such as a message containing button press data or other accessory input that may be transmitted using addresses that have been assigned using a scheme of the type shown in FIG. 9 in accordance with an embodiment of the present invention.

FIG. 11 is a diagram of an illustrative message such as a message containing a volume adjustment command or other command from a host that may be transmitted using addresses that have been assigned using a scheme of the type shown in FIG. 9 in accordance with an embodiment of the present invention.

FIG. 12 is a flow chart of illustrative steps involved in assigning addresses to equipment in a network and involved in conveying data between equipment in the network using the assigned addresses in accordance with an embodiment of the present invention.

### DETAILED DESCRIPTION

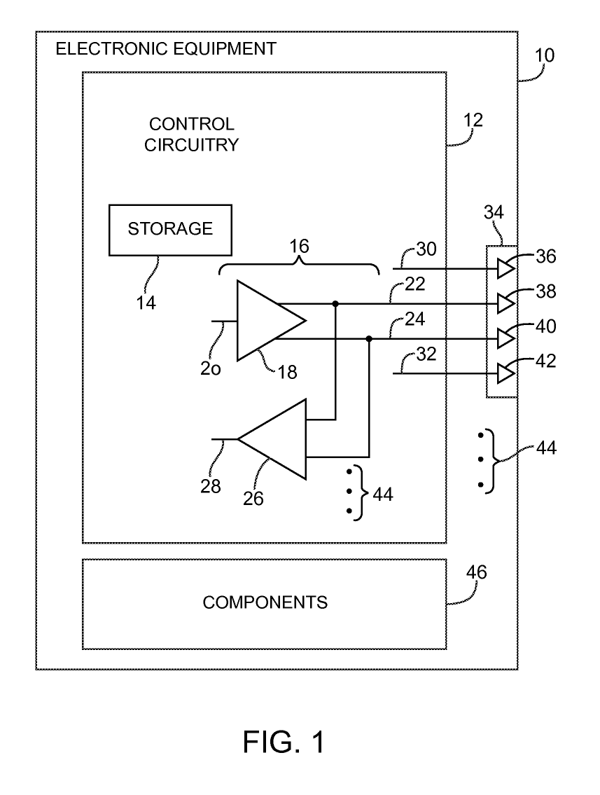

Pieces of electronic equipment such as electronic equipment 10 of FIG. 1 may be interconnected in networks. As shown in FIG. 1, each piece of equipment 10 may include control circuitry 12 including communications circuitry 16 and other components 46. Communications circuitry 16 may include transmitter circuitry such as transmitter 18 and receiver circuitry such as receiver 26. Transmitter 18 may receive digital data on input 20 and may drive corresponding signals onto data output paths 22 and 24 (e.g., as differential data signals corresponding to single-ended data received on line 20). Receiver 26 may have inputs coupled to data lines 22 and 24, respectively. During data reception operations, receiver 26 may convert differential data on lines 22 and 24 into single-ended data on output 28.

Equipment 10 may have a connector such as connector 34. Connector 34 may have four contacts such as contacts 36, 38, 40, and 42. If desired, connectors with other numbers of contacts (e.g., more than four contacts or fewer than four contacts) may be used in equipment 10. The four-contact arrangement of FIG. 1 is merely illustrative.

As shown in FIG. 1, equipment 10 may have power lines such as positive power line 30 and ground power line 32. In connector 34, positive power line 30 may be connected to contact 36, data line 22 may be connected to contact 38, data line 24 may be connected to contact 40, and ground power line 32 may be connected to contact 42. Equipment 10 may contain one or more contacts such as contact 34 and one or more associated transmitters and receivers, as indicated by dots 44 in FIG. 1.

Control circuitry 12 may include processing circuitry based on microprocessors, microcontrollers, application-specific integrated circuits, digital signal processors, and other circuits. Control circuitry 12 may also include storage circuitry 14. Storage circuitry 14 may include hard disk drives, removable storage media, non-volatile memory such as electrically erasable programmable read-only memory, flash, other solid state memory, volatile memory, etc. Storage 14 may be implemented using components that are separate from the processor circuits of control circuitry 12 (e.g., using a memory chip that is separate from an integrated circuit that contains processing circuitry) or may be implemented using memory circuits that are part of an integrated circuit that contains processing circuitry.

During operation, control circuitry 12 may control operations such as generating audio data, processing audio data (e.g., to implement noise cancellation functions), transmitting data (e.g., by packaging data into suitable data structures to be transmitted by transceiver circuitry 16 and by unpacking data that has been received from an external source using transceiver circuitry 16), and other operations. Data interfaces in circuitry 12 may store assigned address information in storage 14.

Electronic equipment 10 may include components 46 such as user input interface components (e.g., displays, touch screens, buttons, speakers, microphones, status lights, sensors, etc.), power circuits (e.g., a battery and power regulator circuitry), etc.

Using cables with connectors that mate with connectors such as connector 34 of FIG. 1 and other interconnection arrangements, multiple pieces of equipment 10 may be interconnected in a network. When interconnected, digital data such as control data and audio data may be conveyed between the various pieces of equipment. In a typical network, different pieces of equipment typically have different hardware configurations and perform different functions.

For example, some of the equipment in a network may serve as a host. In general, hosts can be based on any equipment 10 that can transmit and/or receive digital data such as audio and control data. Examples of equipment 10 that may serve as hosts include desktop computers, portable computers, tablet computers, cellular telephones, and media players. Other types of equipment 10 may serve as hosts if desired. These are merely illustrative examples.

Some of the equipment in the network may include devices such as headsets, accessory speakers, and other accessories that operate in conjunction with hosts. Devices such as these are sometimes plugged directly into a connector port on a host. For example, equipment 10 may be a headset that has a cable that is terminated by a connector such as connector 34 of FIG. 1 (e.g., a plug). The host may have a corresponding jack into which the plug may be connected. Once connected in this way, the host may transmit data to the device such as audio data to be played for a user with speakers in the device. The device may also transmit data to the host. For example, the device may transmit microphone data from a voice microphone and/or noise cancelling microphones to the host. Other equipment 10 may serve as a device in the network such as a pair of amplified speakers, headsets with microphones for gathering voice from a user during a cellular telephone call, headphones with noise cancellation microphones (i.e., headsets with one or more microphones that gather ambient noise signals that can be subtracted from played back audio to mitigate noise), etc.

In some scenarios, equipment 10 may serve as a network hub. Hubs may be interposed between devices and hosts. For example, a hub may be connected to a host and to three devices. As another example, a first hub may be connected between a host and a second hub and the second hub may be connected to a pair of devices. Hubs may be used to provide interconnection flexibility by adding available ports to the network. Device-type components such as speakers and microphones may also be incorporated into hubs if desired to form hybrid hubs that includes both hub-type ports and device-type components.

The inclusion of a hub between a host and a device generally does not affect the quality of audio data that is being conveyed between the host and device, because the hub retransmits digital data with little or no signal loss. Nevertheless, because there are numerous different patterns in which various pieces of equipment 10 can be interconnected, addressing techniques are used to ensure that digital data is conveyed properly to its intended destination. The equipment in a network is typically not provided with addresses until the network is formed. Once desired devices and hubs are connected to a host, addresses may be assigned.

After the addresses are assigned, messages may be conveyed between different pieces of equipment. For example, a device may send a button press message to a host that informs the host of which buttons have been pressed by the user in the device. This message may include a source address (e.g., the address of the device) and a destination address (e.g., the host). In response to receiving the message, the host may take appropriate actions (e.g., to fast forward or reverse media playback, to pause or stop media playback, to answer an incoming telephone call, to mute a call, to change a volume level, to skip tracks, etc.).

The host may likewise use addressed messages to send information to particular devices. For example, a device with an adjustable amplifier may be able to play music through speakers in the device at an adjustable volume level. The user of a host may supply the host with a user input command such as a command to set playback volume at a desired level. In response, host may send an addressed message to the appropriate device that informs the device of the desired volume level. The message may include a source address corresponding to the address of the host and a destination address corresponding to the address of the device.

Data traffic such as audio traffic may be conveyed between pieces of equipment 10 using traffic channels. Traffic channel parameters may be conveyed using messages that contain source and destination addresses (as an example).

The connectors such as connector 34 of FIG. 1 that are used in interconnecting pieces of equipment 10 in a typical system may be audio connectors or other suitable connectors. Audio connectors include male connectors (sometimes referred to as plugs) and female connectors (sometimes referred to as jacks). Audio connectors may be provided in the housing of equipment 10 or may be provided on the ends of cable pigtails. Cables that contain audio connectors at one or both ends may also be used in coupling together equipment. Cables and equipment 10 may, if desired, contain connectors other than audio connectors (e.g., digital connectors such as Universal Serial Bus connectors, 30-pin connectors, etc.).

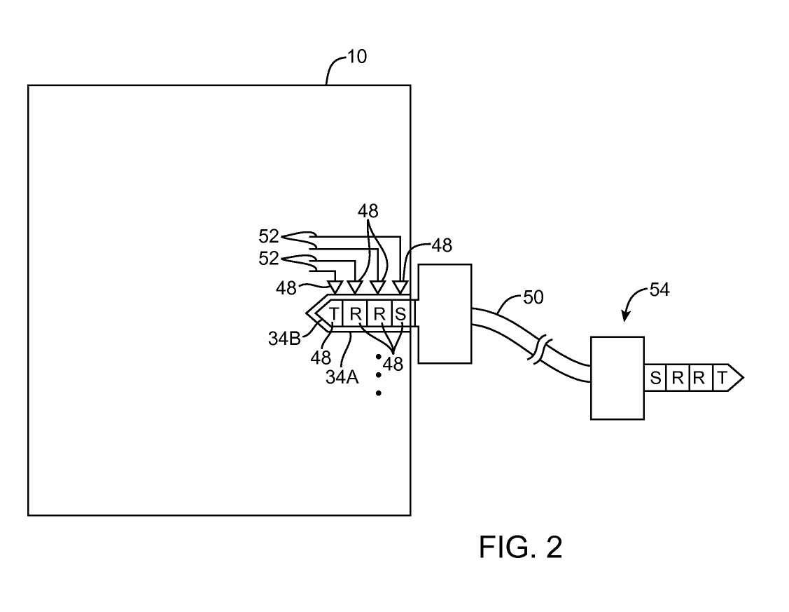

A typical audio connector arrangement is shown in FIG. 2. As shown in FIG. 2, equipment 10 may have a connector such as connector 34A that mates with connector 34B on cable 50. Cable 50 may be pigtailed to another piece of equipment or, as shown in FIG. 2, may be provided with a connector (e.g., connector 54 at the opposite end of cable 50 from connector 34B). In cables with connectors at each end, the connectors may be of the same type or may be of different types. Connector 34A (e.g., an audio jack) may have contacts 48 that are connected to lines 52 in equipment 10. Lines 52 may be connected to data and power lines, as described in connection with FIG. 1. Connector 34B (e.g., an audio plug) may have mating contacts 48. Contacts 48 are sometimes referred to as tip (T), ring (R), and sleeve (S) connectors in a three-contact (TRS) audio connector or a four contact (TRRS) audio connector, as shown in FIG. 2. If desired, mating connectors such as connectors 34B and 34A or connectors of other types may be used to connect pieces of equipment together without involving use of a cable (e.g., by nesting one piece of equipment into a connector receptacle in another piece of equipment so that the connectors in each piece of equipment connect to each other).

Control circuitry 12 of equipment 10 (FIG. 1) may use communications circuitry such as transceiver circuitry 16 in implementing one or more data interfaces. Data that is transmitted from the host to hubs and connected devices is typically referred to as downstream data. Data that is transmitted from devices and hubs to the host is typically referred to as upstream data. The data interfaces that are implemented with control circuitry 12 may include data interfaces for transmitted downstream data (sometimes referred to as downstream or downlink interfaces) and data interfaces for transmitting upstream data (sometimes referred to as upstream or uplink interfaces). The circuits in a device (or hub-device hybrid) that consume data (e.g., synchronous data) are sometimes referred to as endpoints. Endpoints may be associated with components such as speakers and microphones (as examples).

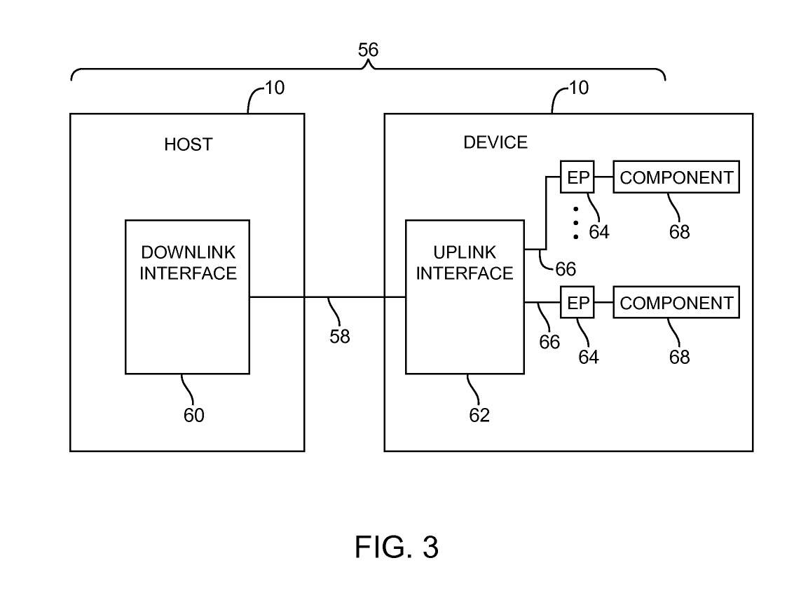

An illustrative system configuration showing how pieces of equipment 10 communicate using respective downlink and uplink interfaces is shown in FIG. 3. In the example of FIG. 3, system 56 includes a host and a device that are connected using communications path 58 (e.g., a cable with two connectors such as cable 50 of FIG. 2, a pigtailed cable with a connector on its free end, two mating connectors without a cable, etc.). Downlink data interface 60 in host equipment 10 may communicate with uplink data interface 62 in device equipment 10 over communications path 58.

Within the device of FIG. 3, uplink interface 62 may communicate with one or more endpoints 64 over one or more respective paths 66. Each endpoint 64 may be connected to a respective one of components 68. Components 68 may include audio components such as microphones and speakers and, if desired, non-audio components. Microphones in components 68 may include voice microphones and noise cancellation microphones. Speakers in components 68 may include speakerphone speakers, powered accessory speakers, earbud speakers, over-the-ear headphone speakers, speakers in a headset that includes one or more microphones, etc. During operation, endpoints 64 and associated components 68 may serve as sources and sinks of synchronous data (e.g., audio data). Synchronous traffic channels may be used to transport data to and from these sources and sinks over paths such as path 58.

As described in connection with equipment 10 of FIG. 1, equipment 10 may include components 46 such as input devices (e.g., push buttons, rotating knobs, sliding switches, touch sensor controls, sensors, touch screens, and other components for receiving button press data and other user input) and output devices (e.g., light-emitting diodes and other status indicator lights, displays, vibrators, tone generators, etc.). A collection of endpoints 64 and input-output components 46 may form a function group in a device or other equipment. Data associated with a function group (e.g., button press data, control data, etc.) may be transmitted over communications paths such as path 58 asynchronously using equipment addresses. For example, in a network with multiple pieces of equipment, each piece of equipment (and function group) can be addressed using fields that are transmitted over an asynchronous data channel on paths such as path 58. This allows a user to transmit data such as button press data from an accessory to a host or to transmit a control command from a host to an accessory.

Each of components 68 may be provided with appropriate support circuitry. For example, microphones may be provided with analog-to-digital converter circuitry for converting analog microphone signals into digital microphone signals. The digital microphone signals may then be processed and provided to uplink interface 62 using communications and processing circuitry in an associated endpoint 64.

As another example, speakers may be provided with associated digital-to-analog converter circuitry, amplifier circuitry, and optional digital signal processing circuitry. During operation, uplink interface 62 may provide digital audio signals to an associate endpoint 64 over an associated path 66. The endpoint may use the digital-to-analog converter circuitry, amplifier circuitry, and optional digital signal processing circuitry that is associated with the speaker for that endpoint to play back the audio signals to a user.

User input-output components may include support circuitry such as circuitry for converting button presses into digital data, circuitry for converting sensor input into digital data, circuitry for converting digital data into status-indicator output, circuitry for converting digital data into displayed images, etc. In a typical user input scenario, a user at a device may press a button or otherwise use an input component to supply user input to the device. This user input may be gathered using the input component. The user input that is gathered in this way may be provided to uplink interface 62 in the form of digital data. Uplink interface 62 can transmit the user input to the host over path 58. In a typical output scenario, output data from a host may be received by a device in digital form over path 58 by uplink interface 62. Uplink interface 62 may route the output data to an appropriate output component. If, for example, the output is data that controls the state of a status light-emitting diode, uplink interface 62 may route a status bit for the light-emitting diode to a circuit that places the light-emitting diode in a desired state (e.g., on or off). Other types of user input and user output may be handled similarly.

If desired, a device may contain only a single endpoint (e.g., a single speaker or microphone). More complex devices will generally contain multiple endpoints. As an example, stereo headphones may include two endpoints for handling left and right audio for a pair of associated speakers. A stereo headset may include three endpoints—one to handle a voice microphone, one to handle a left speaker, and one to handle a right speaker.

A headset may also include more endpoints. For example, a headset may include seven endpoints—a first to handle a voice microphone, a second to handle a left audio channel high-frequency speaker (i.e., a tweeter), a third to handle a left audio channel low-frequency speaker (i.e., a bass driver), a fourth to handle a right audio channel high-frequency speaker (i.e., a tweeter), a fifth to handle a right audio channel low-frequency speaker (i.e., a bass driver), a sixth to handle a left channel noise cancellation microphone, and a seventh to handle a right channel noise cancellation microphone. Headsets with more than seven endpoints may also be used (e.g., to handle surround sound audio, noise cancellation, voice microphone signals, etc.).

In general, a given piece of equipment 10 may include no endpoints (see, e.g., the host of FIG. 3), or one or more endpoints (see, e.g., device 10 of FIG. 3). Devices with one or more endpoints may have, for example, one endpoint, two endpoints, three endpoints, three to five endpoints, three to ten endpoints, more than five endpoints, etc.

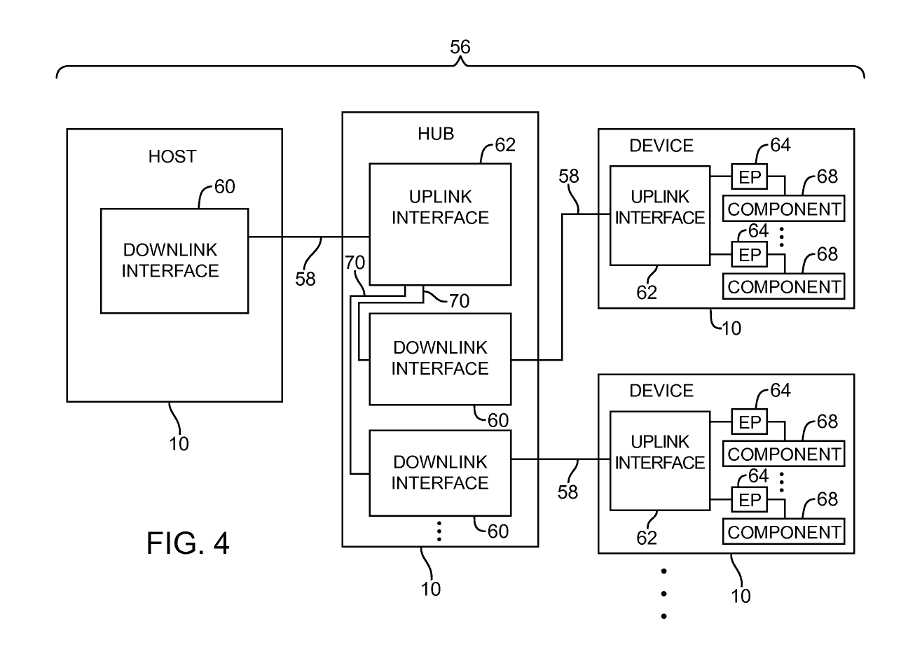

Users may sometimes feel overly constrained with the number of ports available in a given host. For example, a host may only have one connector (e.g., a connector such as connector 34A of FIG. 2) that is available to attach accessories. If multiple users want to share the same host (e.g., if three people would like to listen to the same music that is being played by the host), more ports will be needed (i.e., three ports in this example). One way to ensure that there are a sufficient number of ports available to connect devices to a given host involves the use of hub equipment. As shown in FIG. 4, for example, system 56 may include a hub that is interposed between a host and multiple devices. The hub has an uplink interface that communicates with the downlink interface in the host and has multiple downlink interfaces that communicate with the uplink interface in the hub via communications paths 70. Each of the downlink interfaces in the hub may be used to communicate with an associated uplink interface 62 in a respective device. Each uplink interface in a given device is, in turn, coupled to one or more endpoints, as described in connection with FIG. 3.

Hubs may have any suitable number of ports (each with an associated connector 34). With one illustrative arrangement, which is sometimes described herein as an example, two-digit hexadecimal addresses are used to uniquely identify the downlink interfaces in the hub and up to two layers of hubs are allowed. With this type of system, the most upstream hub (sometimes referred to as the hub that forms a first level of downstream equipment) can be implemented with up to 15 ports. To maximize the number of available ports, a user may connect 15 hubs (i.e., 15 hubs that form a second level of downstream equipment) to the 15 available ports on the first-level hub. If each of the 15 second-level hubs has 15 ports of its own, a total of 225 ports (15*15) will be available, each with a respective downlink interface. A user may connect from 0-225 devices to these available downlink interfaces using paths 58. If desired, larger addressing schemes may be used to accommodate hubs with larger fan-outs, more layers of hubs may be supported, etc. The use of a two-layer hub limit and a maximum of 15 downlink interfaces per hub is merely an example. Each device may have up to 15 endpoints (as an example), so a system with all possible hubs and endpoints would support 3375 distinct endpoints (in this example).

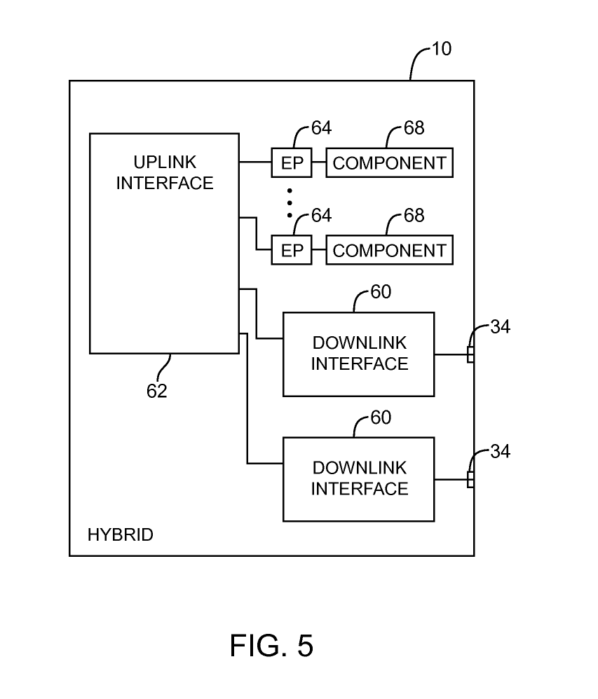

If desired, hybrid equipment may be used that includes both device-type and hub-type circuits. Illustrative hybrid hub-device equipment of this type is shown in FIG. 5. As shown in FIG. 5, hybrid equipment 10 may include an uplink interface (i.e., interface 62 for communicating with upstream equipment such as a host or upstream hub). As with hub-type equipment, hybrid equipment 10 of FIG. 5 may include one or more downlink interfaces 60, each of which has an associated port (having a respective one of connectors 34). As with device-type equipment, the hybrid equipment of FIG. 5 may also include one or more endpoints 64 and associated components 68. An example of a hybrid is a pair of headphones that has an auxiliary port for attaching additional headphones. Another example of a hybrid is a hub-type device that has its own speaker and microphone in addition to ports for attaching headphones.

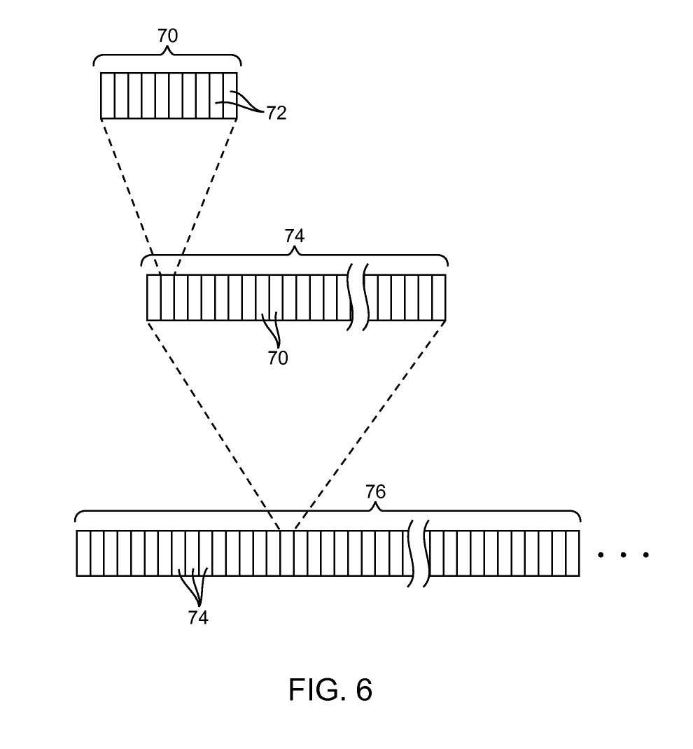

Data may be conveyed between equipment 10 in digital form. With one illustrative arrangement, data may be organized using a frame structure of the type shown in FIG. 6. As shown in FIG. 6, data may be conveyed in a series of superframes 76. Each superframe may contain a number of frames 74. For example, there may be 160 frames per superframe. Each frame 74 may contain a number of slots 70. For example, there may be 34 slot periods per frame.

Each slot may include multiple data bits 72. There may be, for example, 10 bits of 8B/10B encoded data in each slot corresponding to a single data byte. When decoded (e.g., during internal processing in equipment 10), each 10-bit byte of 8B/10B encoded data corresponds to an 8-bit decoded data byte.

The time allotted for each of slots 70 may be, for example, 612.745 ns. Each of frames 74 may occupy 20.833 μs. Superframes 76 may each occupy 3.333 ms. If desired, other configurations may be used (e.g., configurations in which different periods of time are allotted to slots 70, frames 74, and superframes 76, configurations in which there are different numbers of bits 72 in each slot 70, different numbers of slots 70 in each frame 74, and different numbers of frames 74 in each superframe 76, configurations in which the data bits in each slot are encoded using a different encoding scheme or are not encoded, etc.). The arrangement of FIG. 6 is merely illustrative.

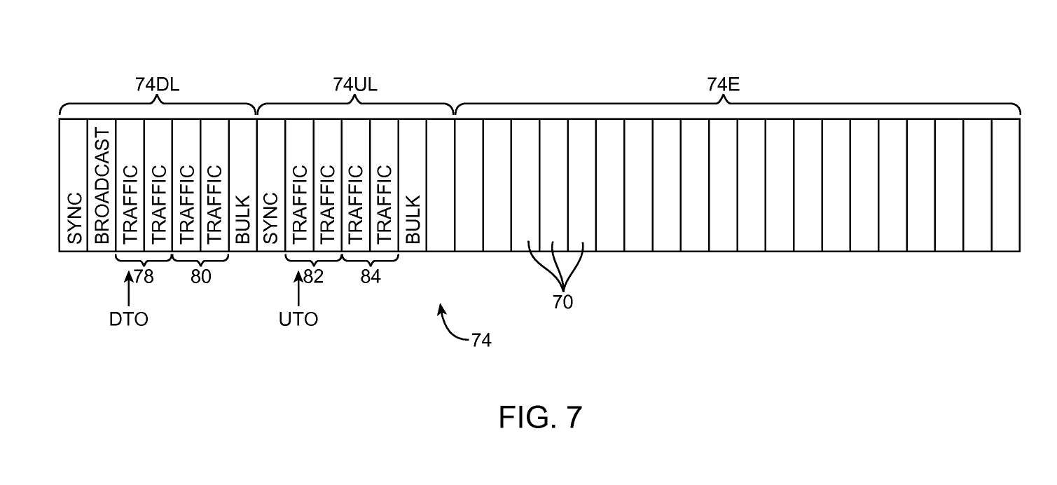

To minimize unnecessary power consumption, frames may be partly utilized in situations in which the bandwidth of a fully-utilized frame is not required. Part of each frame (sometimes referred to as the downlink phase) may be used for downlink data and part of each frame (sometimes referred to as the uplink phase) may be used for uplink data. FIG. 7 shows an illustrative partly-utilized frame. As shown in FIG. 7, frame 74 may include downlink phase portion 74DL, uplink phase portion 74UL, and empty portion 74E. There are 34 of slots 70 in frame 74. Some of slots 70 (i.e., the slots in empty frame section 74E) are unoccupied in the FIG. 7 example. When slots are unoccupied, little or no power need be expended in transmitting and receiving data, so power can be conserved. The remaining slots in frame 74 (i.e., the slots in uplink phase 74UL and downlink phase 74DL) are occupied only to the extent needed to convey the data that is currently being transmitted and received by the equipment in the system.

Consider, as an example, a system in which a host is transmitting left and right audio channels of data to a pair of stereo noise cancellation headphones to be played for a user. Left and right noise cancellation microphones in the headphones may gather and transmit left and right channel noise cancellation microphone signals back to the host for processing (e.g., to subtract from the outgoing stereo audio). Each audio channel in this type of scenario may include data that is acquired using a 48 kHz sampling rate with 16 bits per sample (as an example). To accommodate four channels of audio data of this bandwidth, each channel may be assigned two of slots 70. For example, the host may transmit left audio channel data using a pair of slots 70 in downlink phase 74DL (i.e., slots 78). The host may transmit right audio channel data using slots 80. In uplink phase 74UL, the headphones may transmit microphone signals from the left noise cancelling microphone in slots 82 and from the right noise cancelling microphone in slots 84.

As shown in FIG. 7, the first slot in downlink phase 74DL may be a synchronization (“sync”) byte. The second slot in the downlink phase may be a broadcast byte that forms part of a broadcast channel. Downlink data traffic (e.g., audio signals) may be conveyed in traffic slots such as slots 78 and 80. The downlink phase may also include a bulk slot that is used in forming part of a bulk channel. The first slot in uplink phase 74UL may contain a sync byte. Uplink traffic may be carried in traffic slots 82 and 84. A bulk slot may be included in the uplink phase (e.g., a bulk slot may be included at the end of the uplink phase), forming an uplink bulk channel.

The sync slot in the uplink phase identifies the beginning of transmission for the uplink phase and the sync slot in the downlink phase identifies the beginning of transmission for the downlink phase. Unique sync symbols may be used for the uplink and downlink phases. In arrangements where 8B/10B encoding is used, for example, the symbol K28.5 may be used as a start of downlink sync symbol and the symbol K28.6 may be used as a start of uplink symbol.

The broadcast channel may be used to convey information from the host to all devices in the network. The broadcast channel may be used to carry information such as information related to the assignment of addresses and other network setup information (i.e., network configuration information). The broadcast information that is provided in any given superframe may apply to the beginning of the following superframe. The 160 broadcast slot bytes that are transmitted per superframe are sometimes referred to as forming a 160-byte broadcast message (i.e., a broadcast message formed by concatenating all 160 broadcast bytes of a given superframe).

Each broadcast channel message may include start of superframe identifier information (SOSF). The SOSF may identify the start of each superframe (i.e., the start of each group of 160 frames).

The broadcast channel message may also include version information (HMBV). The value of HMBV may be used to determine the current protocol version being implemented by a given host.

A superframe number (SFN) may be included in each broadcast channel message. The superframe number may be obtained using a rolling counter that is updated each new superframe. The value of SFN may be used in implementing messages across superframes.

Each broadcast channel message may include a value representing the number of slots in downlink phase 74DL (DPS) and a value representing the number of slots in uplink phase 74UL (UPS). The value of DPS may take into account the downlink sync word. The value of UPS may include the uplink sync word.

A pointer to the beginning of the downlink phase (i.e., a downlink phase offset DTO as shown in FIG. 7) and a pointer to the beginning of the uplink phase (i.e., an uplink phase offset UTO as shown in FIG. 7) may be included in the broadcast message. The slots in each frame may be numbered (e.g. from 0 to 159). The value of DTO may be represented using the number of the slot in which the first downlink traffic word is transmitted. The value of UTO may be represented using the number of the slot in which the first uplink traffic word is transmitted.

Each broadcast message may include a downlink interface address (DIA). The value of DIA represents the physical address of the downlink data interface from which the broadcast message was received. In networks that include multiple layers of equipment, such as a network that includes a hub, the intervening equipment (i.e., the hub) receives a DIA from upstream equipment (i.e., the host), but modifies the value of DIA in accordance with the physical address of each of its downlink interfaces. Each downlink interface then retransmits the modified version of the broadcast message downstream. In the retransmitted version of the broadcast messages, the values of DIA are modified to reflect the physical addresses of the downlink interfaces from which the broadcast messages are retransmitted. The downlink interface addresses of the downlink interfaces (e.g., the downlink interfaces in the hub) are not assigned during manufacturing, but rather are assigned only after the network is formed (i.e., dynamically), using the DIA from the downlink data interface that is upstream as a root address.

Broadcast messages may carry downlink bulk channel information (DBC) such as a “start slot” number indicating the placement of the first possible slot occupied by the downlink bulk channel data during the next superframe, “start slot bytes” information indicating the cumulative number of bytes occupied by the downlink bulk channel data in the start slot of the next superframe, an “end slot” number indicating the placement of the last possible slot occupied by downlink bulk channel data during the next superframe, and “end slot bytes” information indicating the cumulative number of bytes occupied by downlink bulk channel data in the end slot of the next superframe.

Broadcast messages may also carry uplink bulk channel information (UBC) such as a “start slot” number indicating the placement of the first possible slot occupied by the uplink bulk channel data during the next superframe, “start slot bytes” information indicating the cumulative number of bytes occupied by the uplink bulk channel data in the start slot of the next superframe, an “end slot” number indicating the placement of the last possible slot occupied by uplink bulk channel data during the next superframe, and “end slot bytes” information indicating the cumulative number of bytes occupied by uplink bulk channel data in the end slot of the next superframe.

Traffic channel allocation information (TCA) may be included in each broadcast message. The traffic channel allocation information may include a channel number for each traffic channel (i.e., a logic number identify the channel), a “start slot” (i.e., a slot number for each traffic channel indicating the first possible slot occupied by that traffic channel during the next superframe), “start slot bytes” information (i.e., the cumulative number of bytes for each traffic channel occupied by that traffic channel in its start slot of the next superframe), an “end slot” number indicating the placement for each traffic channel of the last possible slot occupied by that traffic channel during the next superframe, and “end slot bytes” information (i.e., the cumulative number of bytes for each traffic channel occupied by that traffic channel in its end slot of the next superframe).

If desired, broadcast information may be used to describe the allocation of slots to channels by describing the number of bytes allocated to each slot as follows. For each active traffic slot in the downlink and uplink phases, the broadcast channel may carry bytes that describe the “channel ID” and the number of slots per superframe used by that channel across a superframe. If multiple channels use that slot, then the “allocation” (channel ID+number of used bytes) may be provided in order, such that the number of slots per superframe already allocated to other channels for this slot may be inferred by accumulating the total number of bytes already reserved for that slot by other channels.

A broadcast channel checksum (BCC) may be included in each broadcast message to ensure that equipment can perform a data integrity check of the data received in the broadcast channel. If the data integrity check fails for a broadcast message, the equipment may mute playback (or interpolate audio playback using audio from adjacent superframes).

The downlink phase bulk slots form a downlink bulk channel and the uplink phase bulk slots for an uplink bulk channel. The bulk channels allow data to be transmitted between pieces of equipment 10 with minimal delay. Data with critical timing requirements (i.e., audio data for which low error rates are not generally critical but for which there is a desire for minimal latency) may be transmitted over the traffic channels. Traffic may be allocated among the traffic channels using a data dispersion algorithm that minimizes latency within each channel while ensuring that the number of slots used in each frame is minimized to avoid increasing power consumption. Bulk channel data may be used to transmit address information and other network setup information, button press data and other user input data, status indicator data and other output data, etc. This information may also be transmitted using other formats (e.g., higher-level protocol messages).

Bulk channel data transmissions may use error detection (e.g., cyclic redundancy checking, etc.) and may require transmission of acknowledgement (ACK) signals upon successful data reception. Retransmission upon detection of an error or other failure may or may not be required.

Downlink bulk data may contain error certification information. Uplink bulk traffic may be buffered when hubs are used to accommodate simultaneous upstream transmissions from multiple downstream devices. Data interfaces may be provided with buffer capacity to hold 30 or more bytes of bulk channel data per port (as an example).

Bulk data transfers may begin with the transmission of an 8B/10B value that serves as a start of stream (SOS) symbol. The K30.7 8B/10B symbol or other suitable data pattern may serve as the start of stream symbol. The start of stream symbol may identify the actual location of the start of the bulk data stream. Destination and source addresses (i.e., device-level addresses) may also be included in bulk channel messages. Information such as information on the length of the bulk channel message may be included with a bulk channel message (e.g., to facilitate cyclic redundancy calculations for bulk data).

Initially, equipment 10 such as hubs and devices are not provided with addresses. Rather, addresses are assigned dynamically based on the location of each piece of equipment in the network. The host may have a default address. When equipment is connected together to form a network, the uplink and downlink interfaces communicate and ensure that each piece of equipment is assigned an appropriate address. Thereafter, data may be conveyed throughout the network using the assigned addresses. Because addresses can be assigned dynamically, it is not necessary to provide each piece of equipment with a serial number or other unique identifier during manufacturing, thereby reducing manufacturing cost and system complexity. Hosts may be provided with a default address such as a two-digit hexadecimal address of “00”.

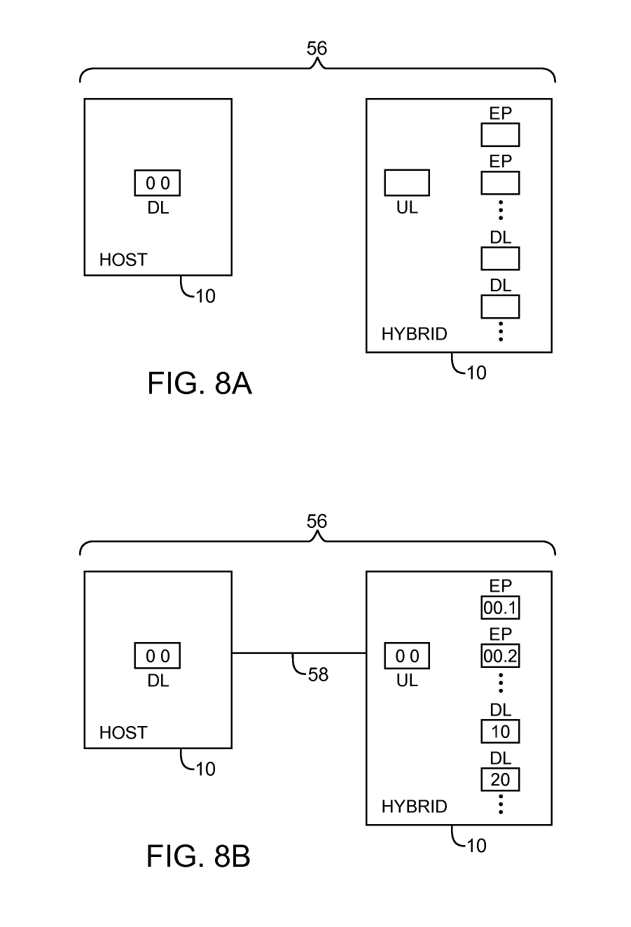

FIGS. 8A and 8B illustrate the process of assigning addresses in a scenario in which there are two pieces of equipment 10: a host and a hybrid. The host has a downlink interface DL that uses storage 14 (see, e.g., FIG. 1) to store its default address. The hybrid has an uplink interface UL, endpoints EP, and downlink interfaces DL (each of which may use storage 14 in storing an associated assigned address). In device-type downstream equipment, only endpoints EP will be present and not downlink interfaces DL. In hub-type downstream equipment, only downlink interfaces will be present and not endpoints.

As shown in FIG. 8A, before the host and downstream equipment have been connected in system 56 (i.e., when the host powers up, but while cable 58 has not yet been used to form a communications path between the host and the downstream equipment), the host has a downlink interface address of 00, whereas the uplink interface UL, endpoints EP, and downlink interfaces DL of the downstream equipment (i.e., the hybrid equipment in the FIG. 8A example) do not have any assigned addresses.

Once the hybrid 10 is connected to host 10 via path 58 as shown in FIG. 8B, addresses may be assigned in the downstream equipment. When path 58 is first formed, the downlink interface address (DIA) may be transmitted to the downstream equipment in the broadcast channel. In response, the downstream equipment may assign the received DIA information from the host to the address of its uplink interface (i.e., the uplink interface address of the downstream equipment may be set to be equal to the received DIA of the host). After setting its uplink interface address in this way, endpoint addresses may be assigned using the address assignment scheme of XY.1, XY.2, XY.3, . . . (where XY represents the uplink interface address, which is equal to the DIA of 00 in this example). Downlink interface addresses in first-level downstream equipment may be assigned using the address assignment scheme of 1Y, 2Y, 3Y, . . . , where Y represents the second digit in the uplink interface address (equal to the second digit 0 in the DIA in this example).

When more levels of equipment are involved, superframes of data may be conveyed in both downstream and upstream directions (e.g., by retransmission of data in the downstream direction and by merging data in the upstream direction). For example, when a host or other upstream device transmits a superframe to downstream equipment, the downstream equipment receives the transmitted superframe and retransmits the superframe to any equipment that is further downstream. If desired, the downstream equipment may filter a superframe as part of retransmitting the superframe so that downstream equipment only receives relevant portions of the superframe. Similarly, when downstream equipment is transmitting data upstream, the upstream device that receives the transmitted data is responsible for retransmitting the received data further upstream and may be responsible for merging data transmitted from multiple pieces of downstream equipment into one or more superframes.

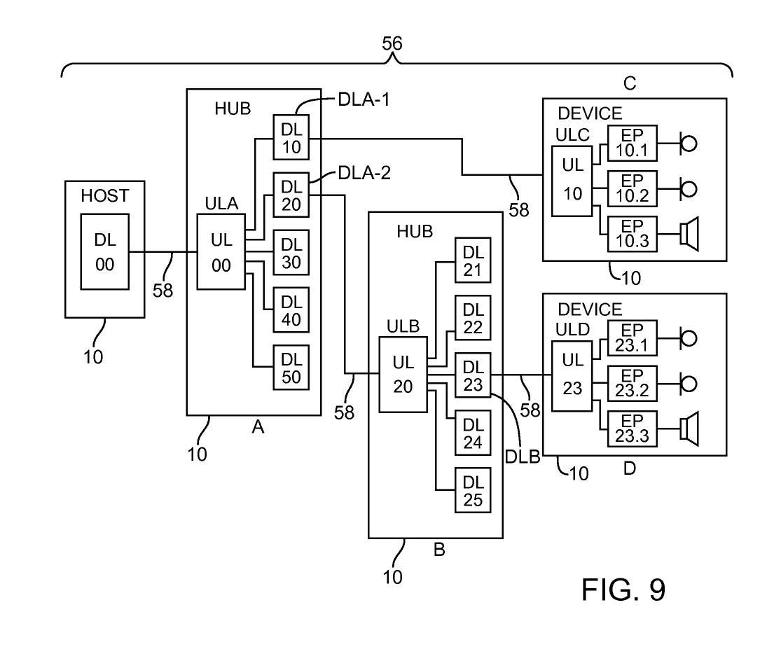

As with single-layer equipment networks, addresses may be assigned in multilayer equipment networks using the broadcast channel in the downlink phase of each superframe. As each superframe is transmitted downstream, the downlink interface address in the broadcast channel may be updated to be equal to that of the downlink interface address of the downlink interface that is performing the retransmission operation (i.e., the DIA value that is received from upstream equipment is replaced with the DIA value of the retransmitting downlink interface). The type of address assignments that result in a multilevel equipment network are shown in the example of FIG. 9.

As shown in FIG. 9, the host may have a DIA of 00. The DIA of the host is transmitted to the uplink interface ULA of hub A. Uplink interface ULA of hub A may assign the value of the received DIA address (i.e., 00) from the downlink interface of the host to its uplink interface address (UIA).

After the UIA of uplink interface ULA has been set to 00, the DIA values for the downlink interfaces in hub A can be assigned using the address assignment scheme of 1Y, 2Y, 3Y, . . . , where Y is the second digit of the UIA in hub A (which is equal to the DIA of the host).

As a result, downlink interface DLA-1 is assigned a DIA of 10 and downlink interface DLA-2 is assigned a DIA of 20. Downlink interfaces DLA-1 and DLA-2 retransmit superframes that have been received from host 10 using uplink interface ULA. In doing so, DLA-1 broadcasts its value of DIA to device C in the broadcast channel (i.e., 10) and DLA-2 broadcasts its value of DIA (i.e., 20) to hub B in the broadcast channel.

Upstream interface ULC of device C receives the retransmitted superframe from downlink interface DLA-1 and extracts the DIA value of 10 that is associated with downlink interface DLA-1 of hub A. In response, the UIA of uplink interface ULC is set to 10. The addresses of the associated endpoints in device C are assigned accordingly (i.e., to 10.1, 10.2, 10.3, . . . , using the address assignment scheme of XY.1, XY.2, . . . , where XY is the UIA of the uplink interface that is associated with the endpoints.)

Hub A represents a first level of downstream equipment, because hub A is attached directly to host 10. Hub B represents a second level of downstream equipment, because hub B is attached to host A through first level equipment (i.e., hub A). Second level hub B uses uplink interface ULB to receive the superframe that is being retransmitted by downlink interface DLA-2. Hub B extracts the DIA of downlink interface address DLA-2 from the broadcast channel of the retransmitted superframe (i.e., the DIA value of 20 in the FIG. 9 example) and assigns its UIA to this value (i.e., the UIA of hub B is assigned to 20). Hub B is aware of its second level status by virtue of the non-zero value of the first digit in its UIA. Because hub B is located in the second level downstream from the host, a different downlink interface address assignment scheme is used in hub B than in hub A. In particular, hub b assigns its downlink interfaces addresses DIA using the scheme X1, X2, X3, etc., where X is the first digit of UIA associated with uplink interface ULB.

Device D is connected to downlink interface DLB in system 56. Downlink interface DLB retransmits the superframe received from downlink interface DLA-2 by uplink interface ULB and, in retransmitting the superframe, replaces the DIA in the broadcast channel with the DIA value of DLB (i.e., 23). Uplink interface ULD in device D receives this DIA value and assigns it to the UIA of uplink interface ULD (i.e., the UIA of uplink interface ULD is set to 23 in this example). Endpoint addresses for the endpoints of device D are assigned using the address assignment scheme of XY.1, XY.2, XY.3 . . . , where XY represents the first and second digits of the UIA of uplink interface ULD.

Once the addresses have been assigned, data may be routed within the network of equipment 10 (i.e., system 56 of FIG. 9) using the addresses. For example, information in the broadcast channel may be used to identify where the bytes for each traffic channel are located within each frame. This allows endpoints to receive desired data streams from the host. The uplink and downlink interface addresses in the network may be used in addressing bulk channel messages.

Bulk channel messages may be used to convey user input and output data within the system. Bulk channel messages may include information such as a destination address (i.e., the address of a destination such as the downlink interface of the host or the uplink interface of a downstream device), source address (i.e., the address of the originating equipment in the system), bulk data (e.g., button press data or other user input, output data such as status data, etc.), and a bulk message error correction code such as a checksum (e.g., a cyclic redundancy check code).

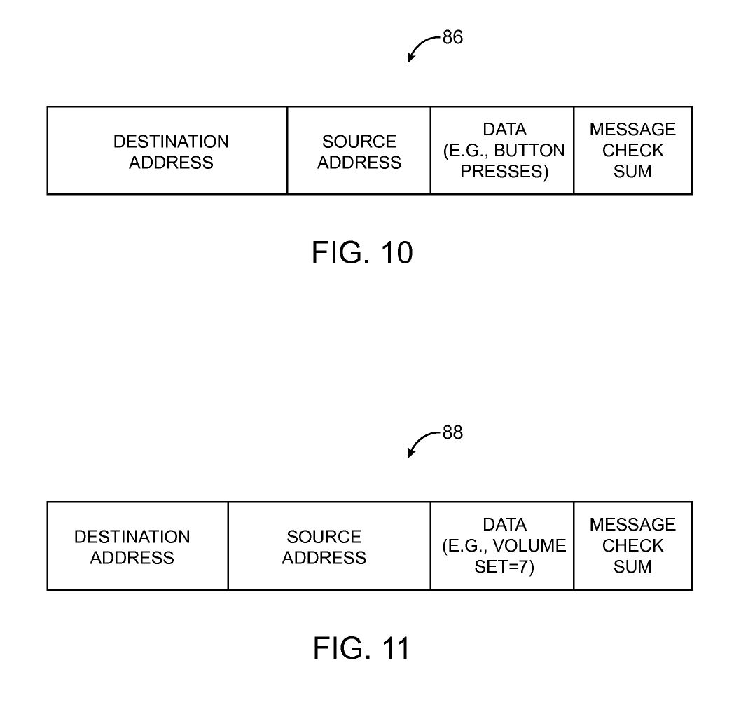

FIG. 10 is an example of a bulk channel message that is being transmitted upstream from a device such as a headset with a button. The destination address in bulk channel message 86 may correspond to the host. The source address may correspond to the UTA of the headset. The bulk data in bulk channel message 86 may correspond to button press data. A checksum may be included to help the destination data interface determine whether errors have been introduced into the bulk data as part of the transmission process.

FIG. 11 is an example of a bulk channel message that is being transmitted downstream from a host to a device such as a device with amplified speakers. The amplifier in the device may have an adjustable amplifier that can be used to set different volume levels for the amplified speakers. The destination address in bulk channel message 88 may correspond to the UIA of the amplified speakers. The source address in bulk channel message 88 may correspond to the address of the host. The bulk data in message 88 may correspond to volume settings data (as an example). The checksum may be used to help detect the presence of errors.

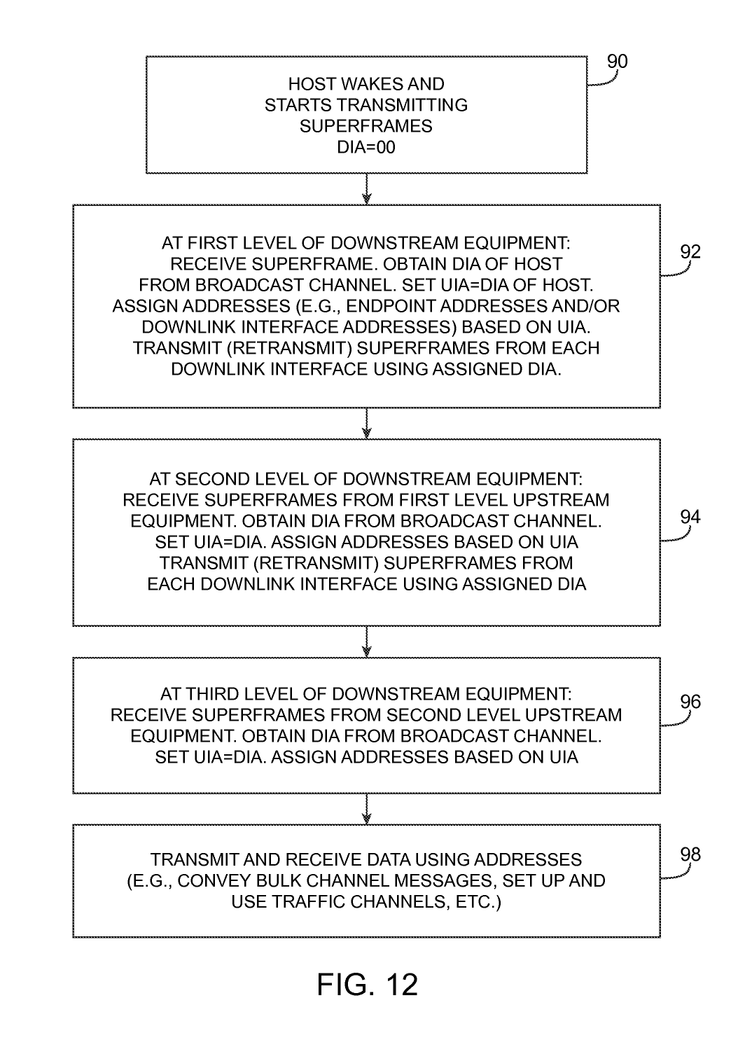

Illustrative steps involved in setting up and using a network of equipment 10 (e.g., a host, hubs, and devices) in an configuration in which there are two layers of downstream hubs and three layers of downstream equipment (e.g., a network of the type shown in the example of FIG. 9) are shown in FIG. 12.

At step 90, the host is powered on. The host DIA (in this example) is 00. During the operations of step 90, the host uses its downlink interface to transmit the DIA value of 00 to downstream equipment. The DIA of the host may be transmitted in the broadcast channel.

At step 92, equipment that is one level downstream from the host such as device A in the example of FIG. 9, may receive the transmitted DIA from the broadcast channel using an uplink interface. The receiving equipment (e.g., device A in FIG. 9) may then set the uplink interface address (UIA) of the uplink interface in the receiving equipment to the received DIA. After the UIA value has been set, the addresses of any endpoints and downlink interfaces in the receiving equipment may be assigned. Endpoint addresses may be assigned using the address assignment scheme of XY.1, XY.2, XY.3, . . . , where XY represents the UIA. Downlink interface addresses may be assigned using the address assignment scheme of 1Y, 2Y, 3Y, . . . , where Y represents the second digit in the UIA. Each downlink interface in the first-level of downstream equipment then retransmits a superframe that has been received by the uplink interface and, during the retransmission, replaces the DIA in the broadcast channel with its own assigned DIA.

At step 94, at equipment that is two levels downstream from the host (e.g., device C and hub B in the network of FIG. 9), uplink interfaces each receive a corresponding DIA (by extracting the DIA from the broadcast channel of the retransmitted superframe). The UIA values in the equipment are then updated accordingly (e.g., each UIA value is set to a corresponding received DIA value). Endpoint addresses in this equipment may be set using the address assignment scheme of XY.1, XY.2, . . . , where XY is the updated UIA. The DIA values of the downlink interfaces in the equipment that is two levels down from the host may be assigned using the address assignment scheme of X1, X2, X3, etc., where X is the first digit of updated UIA. After the DIA values have been set, each downlink interface retransmits superframes in which the DIA has been updated to match its DIA. (In the example of FIG. 9, downlink interface DLB transmits its DIA value of 23.)

At step 96, at the equipment that is three levels away from the host (e.g., at device D in the FIG. 9 example), the transmitted DIA values from the second level of equipment are received by the uplink interfaces in the third-level equipment. UIA values may be updated (i.e., by setting these UIA value for each uplink interface to the value of the DIA that is received by that uplink interface). Endpoint addresses may then be assigned using an address assignment scheme of XY.1, XY.2, XY.3, etc., where XY is the updated UIA of the uplink interface associated with the endpoints.

Information on assigned addresses may be conveyed between pieces of equipment in the network (e.g., equipment that is downstream from the host may upload address information to the host using messages formed from the slots in the uplink phase). The host and other equipment in the system may then use assigned addresses in determining how to send and receive data. For example, traffic channels may be set up and used to convey audio data and other synchronous data, bulk messages such as the illustrative bulk messages of FIGS. 10 and 11 may be sent and received, etc.

The foregoing is merely illustrative of the principles of this invention and various modifications can be made by those skilled in the art without departing from the scope and spirit of the invention.

What is claimed is:

1. A method for supporting communications in a network of equipment, comprising:
at a first downlink interface having a first downlink interface address, transmitting data including the downlink interface address; and
at an uplink interface that communicates with the first downlink interface address over a communications path, receiving the downlink interface address and setting an uplink interface address that is associated with the uplink interface to the received downlink interface address.

2. The method defined in claim 1 wherein the uplink interface is part of equipment that includes a plurality of second downlink interfaces, the method further comprising assigning respective downlink interface addresses to each of the plurality of second downlink interfaces based on the uplink interface address.

3. The method defined in claim 2 further comprising transmitting a message over the communications path that includes the uplink interface address and the first downlink interface address.

4. The method defined in claim 1 further comprising transmitting a message over the communications path that includes at least the uplink interface address.

5. The method defined in claim 4 wherein transmitting the message comprises transmitting frames each of which contains a plurality of slots of data.

6. The method defined in claim 5 wherein the frames each contain at least a given slot that is associated with a channel, wherein transmitting the message comprises transmitting the message over the channel, and wherein the message includes button press data associated with user presses of a button in the equipment.

7. The method defined in claim 6 wherein transmitting the message comprises transmitting the message through at least one audio connector in the communications path.

8. A method for supporting communications in a network that includes a host, a hub, and a device, comprising:
with an uplink data interface in the hub, receiving a downlink interface address that is associated with a downlink data interface in the host; and
at the hub, setting an uplink interface address that is associated with the uplink data interface to the received downlink interface address.

9. The method defined in claim 8 wherein the hub comprises a plurality of downlink data interfaces, the method further comprising:
using the uplink interface address in assigning respective downlink interface addresses to each of the plurality of downlink interfaces.

10. The method defined in claim 8 wherein the hub comprises a plurality of downlink data interfaces, the method further comprising:
assigning respective downlink interface addresses to each of the downlink interfaces, wherein each assigned downlink interface address includes at least part of the uplink interface address.

11. The method defined in claim 8 wherein the hub comprises a plurality of downlink data interfaces, the method further comprising:
with the uplink interface in the hub, assigning respective downlink interface addresses to each of the downlink interfaces each of which includes at least one digit of the uplink interface address.

12. The method defined in claim 8 further comprising transmitting data from the hub through at least one tip-ring-ring-sleeve connector.

13. A method of assigning addresses in a network that includes a host, a hub, and a device, comprising:
with an uplink data interface in the device, receiving a downlink interface address that is associated with a downlink data interface in the hub; and
at the device, setting an uplink interface address that is associated with the uplink data interface to the received downlink interface address.

14. The method defined in claim 13 wherein the device comprises a plurality of endpoints each of which is associated with an audio component, the method further comprising:
using the uplink interface address in assigning respective endpoint addresses to each of the plurality of endpoints.

15. The method defined in claim 13 wherein the device comprises a plurality of endpoints each of which is associated with an audio component, the method further comprising:
assigning respective endpoint addresses to each of the endpoints each of which includes at least two digits of the uplink interface address.

16. The method defined in claim 13 wherein the host, hub, and device are connected using cables that include audio connectors, the method further comprising:
transmitting data from the device to the host that passes through the audio connectors.

17. Equipment, comprising:
an uplink data interface that receives broadcast data over an upstream communications path, wherein the broadcast data includes a first downlink interface address that is associated with an upstream downlink data interface; and
at least one downlink data interface that has a second downlink interface address that is different than the first downlink interface address, wherein the downlink data interface is configured to retransmit a version of the broadcast data in which the first downlink interface address is replaced with the second downlink interface address.

18. The equipment defined in claim 17 further comprising at least one audio connector through which the uplink data interface receives the broadcast data.

19. The equipment defined in claim 18 further comprising at least one speaker.

20. The equipment defined in claim 19 wherein the downlink data interface is configured to retransmit the version of the broadcast data in a broadcast channel formed from broadcast slots in multiple frames of data that are transmitted through the audio connector.

21. An accessory that is operable to communicate with a host, comprising:
at least one microphone;
at least one speaker; and
an uplink data interface that is configured to receive frames of data that are organized in superframes from the host, wherein each frame includes at least one slot of broadcast data, wherein the broadcast data forms part of a broadcast message, and wherein the uplink data interface is configured to assign a first address that is associated with the microphone using a downlink interface address associated with the host that is received in the broadcast message, and wherein the uplink data interface is configured to assign at second address that is associated with the speaker using the downlink interface address.

22. The accessory defined in claim 21 further comprising a button that generates button press data when operated by a user, wherein the uplink data interface is configured to transmit the button press data to the host in a message that includes the downlink interface address.

23. The accessory defined in claim 22 further comprising a cable that has an audio connector, wherein the uplink data interface is configured to receive digital audio data from the host through the cable and audio connector and is configured to route the received digital audio data to the speaker.

24. A network, comprising:
a host that has a first connector and that has a first digital downlink data interface coupled to the first connector;
a hub that has second and third connectors, that has a first digital uplink data interface coupled to the second connector, and that has a second digital downlink data interface coupled to the third connector;
a headset that has a fourth connector, that has a second digital uplink data interface coupled to the fourth connector, and that has a microphone and a speaker coupled to the second digital uplink data interface; and
a first communications path between the first connector and the second connector; and
a second communications path between the third connector and the fourth connector.

25. The network defined in claim 24 wherein the first connector comprises an audio connector, wherein the second connector comprises an audio connector, wherein the third connector comprises and audio connector, and wherein the fourth connector comprises an audio connector, wherein the first digital uplink data interface has an uplink interface address, wherein the first digital downlink data interface has an associated first downlink interface address, wherein the first digital uplink data interface is configured to receive the first downlink interface address in a plurality of frames of data from the host and is configured to assign the first downlink interface address to the uplink interface address, wherein the second digital downlink data interface is configured to retransmit a version of the plurality of frames to the second digital uplink data interface in which the first downlink interface address is replaced with a second downlink interface address that is associated with the second digital downlink data interface.

26. A method of conveying button press information from a first piece of equipment that has a button that generates the button press data to a second piece of equipment, wherein the first piece of equipment includes a first connector, wherein the second piece of equipment includes a second connector, and wherein the first and second connectors are connected by a communications path, the method comprising:
with a first data interface in the first piece of equipment, sending a message to a second data interface in the second piece of equipment that includes a source address associated with the first piece of equipment, a destination address associated with the second piece of equipment, and the button press data.

27. The method defined in claim 26 wherein the first connector comprises a first audio connector, wherein the second connector comprises a second audio connector, and wherein sending the message comprises sending the message in a bulk channel formed from bulk slots in frames that are transmitted as part of a superframe.

28. The method defined in claim 27 further comprising:
at the first piece of equipment, assigning an uplink interface address to the first data interface that is based on a received downlink interface address from the second piece of equipment.

29. The method defined in claim 28 wherein the first piece of equipment includes a speaker and wherein the second piece of equipment comprises equipment selected from the group consisting of: a cellular telephone, a computer, and a media player.

30. A headset, comprising:
an audio connector;
a speaker; and
an uplink data interface that receives digital data through the audio connector including digital audio data that is played through the speaker, wherein the uplink data interface is configured to obtain a downlink interface address from the received digital data and is configured to set an uplink interface address that is associated with the uplink data interface to be equal to the downlink interface address.

31. The headset defined in claim 30 wherein the audio connector comprises a four-contact audio plug that is connected to the uplink data interface.

32. The headset defined in claim 31 further comprising a user input interface component that receives user input from a user, wherein the uplink data interface is configured to transmit the user input through the audio connector in a plurality of frames of data within a superframe, each frame of data including a plurality of 8B/10B encoded data bytes.
